(19) United States
(12) Patent Application Publication
(10) Pub. No.: US 2017/0206110 A1
(43) Pub. Date: Jul. 20, 2017

(54) Computer System for BMC resource management

(71) Applicant: American Megatrends Inc., Norcross, GA (US)

(72) Inventor: Jen HUANG, Taipei City (TW)

(21) Appl. No.: 14/997,671

(22) Filed: Jan. 18, 2016

(51) Int. Cl. G06F 9/50; G06F 9/455

(52) U.S. Cl. CPC G06F 9/50; G06F 9/45558

(57) ABSTRACT

A computer system is provided for baseboard management controller resource management. The computer system includes a plurality of physical computer devices, a first management device, and a second management device. The first management device is coupled to at least a portion of the plurality of physical computer devices, wherein the first management device has a plurality of first virtual machines respectively corresponding to different physical computer devices of the portion of the plurality of physical computer devices. The second management device is coupled to the first management device, and the second management device has a plurality of second virtual machines, wherein each of the second virtual machines respectively corresponds to different physical computer devices of another portion of the plurality of physical computer devices. The first management device and second management device manage allocation of resources for the first virtual machines and second virtual machines to manage the physical computer devices.

### BACKGROUND

1. Technical Field

The present disclosure generally relates to a computer system for managing baseboard management controller resources; particularly, the present disclosure relates to a computer system for managing virtualizations of baseboard management controller units and the resources allocated thereof.

2.Description of the Related Art

Server systems are widely used in many different areas such as datacenters. As such systems become increasing complex and networked, the task of managing their operating environment has also become equally important. Typically, many servers include baseboard management controllers that communicate with components and sensors within the servers to manage the operating environment. As server systems become increasingly networked and complex, efforts are being made to further extend these hardware benefits through virtualization in order to share hardware and reduce redundancy. However, when these virtual machines fail, no warning or notification are given, and management of the baseboard management controllers of the server systems cease to perform properly.

### SUMMARY

It is an objective of the present disclosure to provide a computer system providing virtualization solutions in baseboard management controller management and monitoring.

It is another objective of the present disclosure to provide a computer system with built-in fail-safe mechanisms to prevent malfunctioning management devices from affecting the performance of the entire computer system.

It is yet another objective of the present disclosure to provide a computer system that can decrease hardware costs for baseboard management controller management.

According to one aspect of the invention, a computer system is provided for baseboard management controller resource management. The computer system includes a plurality of physical computer devices, a first management device, and a second management device. The first management device is coupled to at least a portion of the plurality of physical computer devices, wherein the first management device has a plurality of first virtual machines respectively corresponding to different physical computer devices of the portion of the plurality of physical computer devices. The second management device is coupled to the first management device, and the second management device has a plurality of second virtual machines, wherein each of the second virtual machines respectively corresponds to different physical computer devices of another portion of the plurality of physical computer devices. The first management device and second management device manage allocation of resources for the first virtual machines and second virtual machines to manage the physical computer devices.

### BRIEF DESCRIPTION OF THE DRAWINGS

FIG. 1 is a view of an embodiment of the computer system;

FIG. 2A is a view of a management device of FIG. 1;

FIG. 2B is an embodiment of the virtualization schematic of the baseboard management controller attributes in the management device of FIG. 2A;

FIG. 2C is another embodiment of FIG. 2B;

FIG. 2D is another embodiment of FIG. 2C;

FIG. 2E is another embodiment of FIG. 2D;

FIG. 3A is another embodiment of the management device of FIG. 2A;

FIG. 3B is a flowchart of the management device of FIG. 3A checking the availability of the physical computer devices;

FIG. 3C is another embodiment of FIG. 3B;

FIG. 4 is an embodiment of the computer system with a master management device;

FIG. 5A is another embodiment of the computer system of FIG. 4; and

FIG. 5B is another embodiment of the computer system of FIG. 5A.

### DETAILED DESCRIPTION OF THE PREFERRED EMBODIMENT

Embodiments of the present invention provide a computer system for managing virtual baseboard management controllers and the resources allocated thereof. In the following detailed description, references are made to the accompanying drawings that form a part hereof, and in which are shown by way of illustration specific embodiments or examples. These embodiments are only illustrative of the scope of the present invention, and should not be construed as a restriction on the present invention. Referring now the drawings, in which like numerals represent like elements through the several figures, aspects of the present invention and the exemplary operating environment will be described.

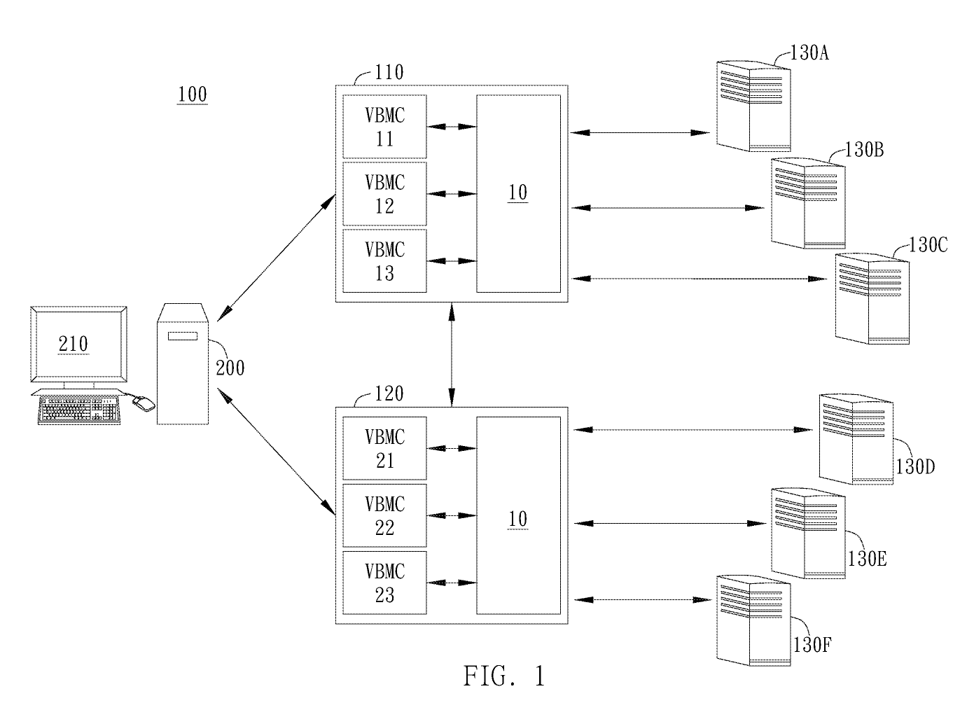

FIG. 1 illustrates an embodiment of the computer system 100 of the present invention. The computer system 100 preferably includes a plurality of physical computer devices 130A˜130F, first management device 110, and second management device 120. As illustrated in FIG. 1, the plurality of physical computer devices 130A˜130F are either coupled to the first management device 110 or the second management device 120. In the present embodiment, the physical computer devices 130A˜130F are preferably server computers. However, in other different embodiments, physical computer devices 130A˜130F may also be any other computer devices, such as desktop computers, laptop computers, and any other related computer devices. It should also be noted that the first management device 110 and the second management device 120 are not limited to only being able to connect to 3 physical computer devices, since it is understood by one skilled in the art that the first management device 110 and the second management device 120 may connect to any number of physical computer devices that they may respectively handle.

In the present embodiment, the physical computer devices 130A˜130F are connected to the first management device 110 and the second management device 120 through a network. The network may consist of the internet or a local area network. In other words, the first management device 110 and the second management device 120 may communicate with the plurality of physical computer devices locally, or remotely through an internet network.

Referring to FIG. 1, in the present embodiment, the first management device 110 and the second management device 120 are preferably server computers used for managing and monitoring the physical state of the physical computer devices 130A˜130F. In an embodiment, the physical computer devices 130A˜130F include sensors measuring physical variables such as temperature, humidity, power-supply voltage, fan speeds, communications parameters and operating system functions, wherein these physical variables are monitored and managed by the first management device 110 and/or the second management device 120. However, those skilled in the art will recognize that the sensors are not limited or restricted to measuring the mentioned physical variable.

In the present embodiment, administrators can monitor various states of the physical computer devices 130A˜130F by connecting to the first management device 110 and/or the second management device 120 with the terminal device 200. In one embodiment, the terminal device 200 may display monitoring status of the physical computer devices 130A˜130F through a Web User Interface on the display 210. Administrators can remotely connect to either the first management device 110 or the second management device 120 through a web browser running on the terminal device 200. In other different embodiments, application software may be installed on the terminal device 210 to interface with the first management device 110 and/or the second management device 120. Administrators may monitor the statuses of the physical computer devices 130A˜130F through the first management device 110 and/or second management device 120, as well as transmit instructions to the first management device 110 and/or second management device 120 to calibrate or modify how the first management device 110 and/or second management device 120 monitors or manages the physical computer devices 130A˜130F.

For instance, Administrators may set rules such as ranges, limits, or boundaries for monitoring of the variables detected by the sensors in the physical computer systems 130A˜130F. When the first management device 110 or the second management device 120 detect that one of the variables of a particular physical computer device has exceeded the limit or range set by the Administrator, the first management device 110 or the second management device 120 may notify the Administrator. In other different embodiments, the first management device 110 and/or the second management device 120 may also be set to automatically handle these situations, such as restarting that particular physical computer device.

As illustrated in FIG. 1, the first management device 110 and the second management device 120 are communicably connected with each other. In one embodiment, the Administrator can connect to one of the first management device 110 and the second management device 120 to monitor the status of a particular physical computer device that is connected to the other of the one of the first management device 110 and the second management device 120. In other words, the Administrator can connect to the first management device 110 and still be able to monitor the status of the physical computer devices 130D˜130F connected to the second management device 120, or the Administrator can connect to the second management device 120 to monitor the status of the physical computer devices 130A˜130C. In this manner, more connection options are available to the Administrator, or connections made by the terminal device 200 may be restricted to only one of the first management device 110 and the second management device 120 in order to prevent too many gateways into the computer system 100 as well as to ensure the security of the computer system 100. Additionally, in the present embodiment, the first management device 110 and the second management device 120 can also monitor each other. For instance, if the first management device 110 were to malfunction, the Administrator would ordinarily not be notified of this problem or event until at a later stage in time when problems resulting from the malfunctioning first management device 110 has cascaded to the point of irreplicable damage has been caused. However, with the cross monitoring mechanism between the first management device 110 and the second management device 120, the second management device 120 would be well aware of the status of the malfunctioning first management device 110 and can notify the Administrator and/or proceed to reboot the first management device 110. In this manner, Administrator can be immediately made aware of problems so that a corrective measure may be subsequently undertaken. As well, another added benefit to the mentioned cross monitoring mechanism is that it acts as a fail-safe mechanism to prevent further problems from occurring.

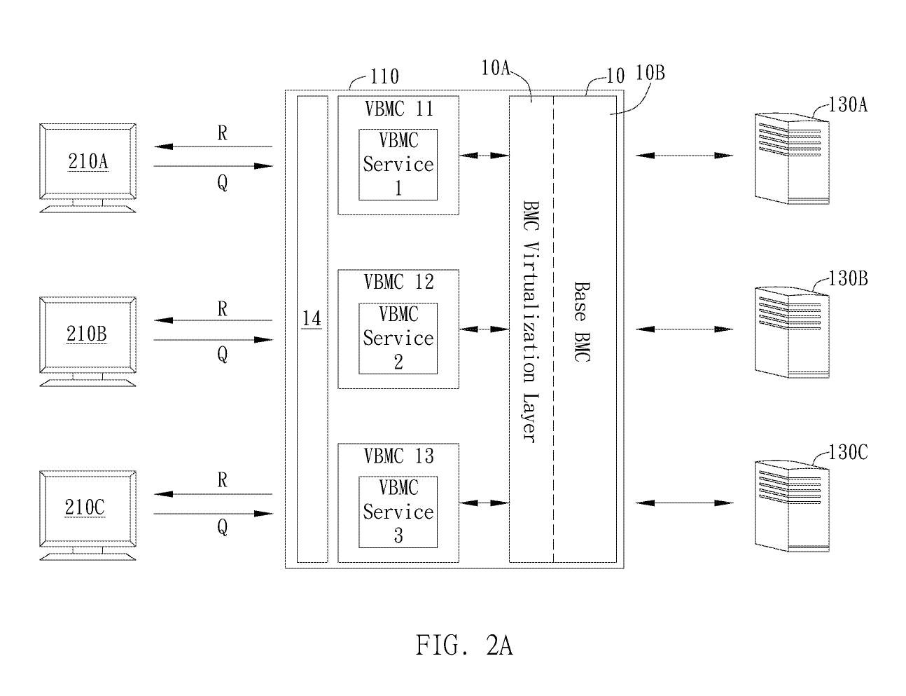

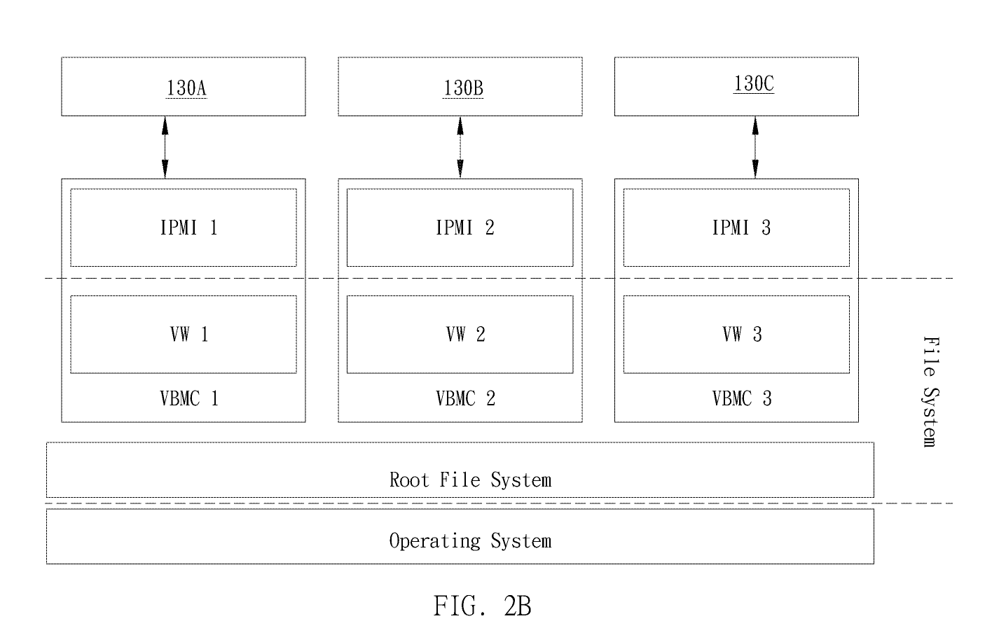

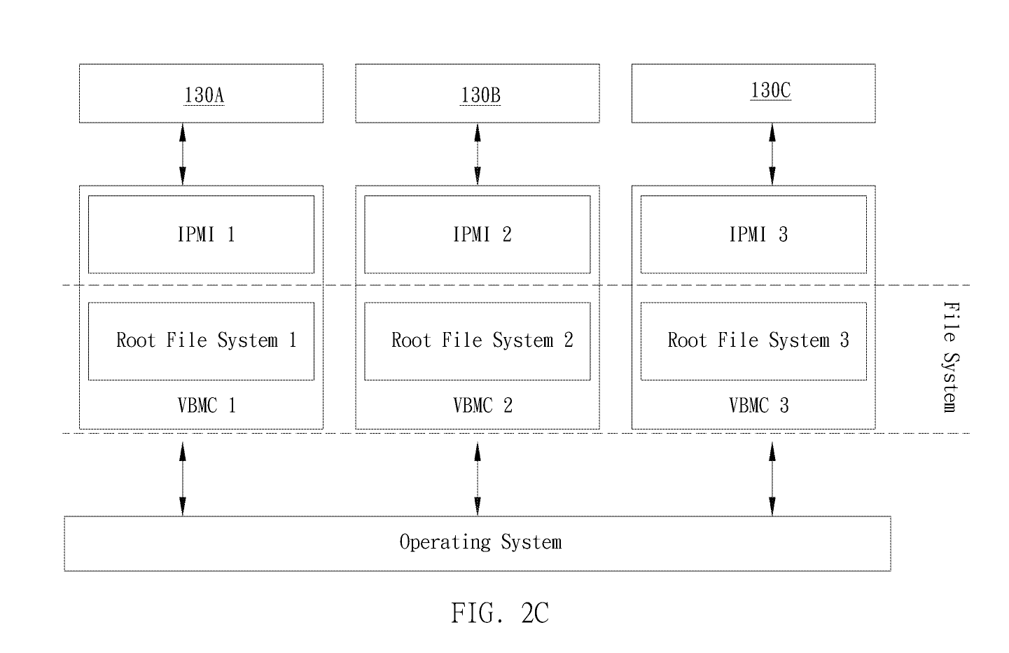

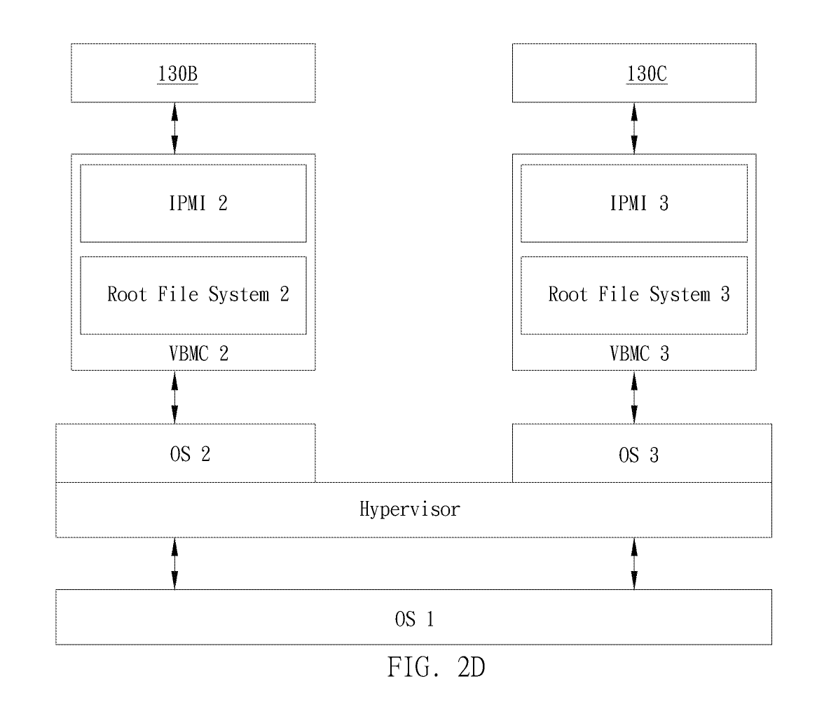

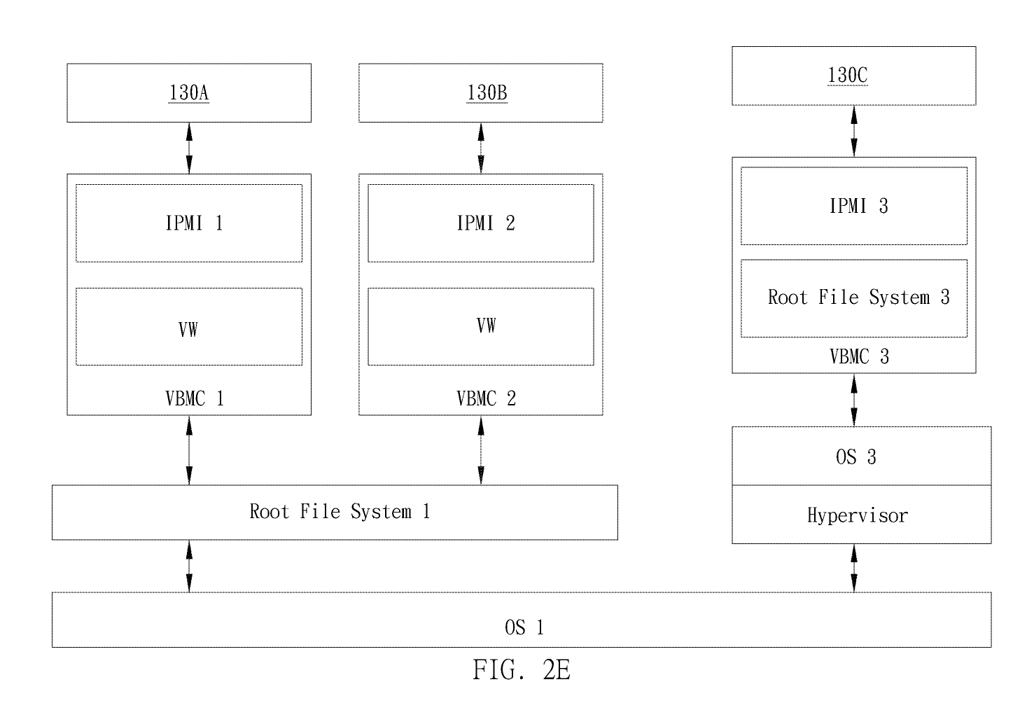

Referring to FIG. 2A, FIG. 2A is an embodiment of the first management device 110 of FIG. 1. As illustrated in FIG. 2A, in the present embodiment, the physical computer devices 130A˜130C are communicably connected to a BMC module 10 of the first management device 110. In the present embodiment, the BMC module 10 handles communication between the first management device 110 and the physical computer devices 130A˜130C. As well, the BMC module 10 also handles allocation of hardware resources for the managing/monitoring of the BMC sensors of the physical computer devices 130A˜130C. Preferably, the BMC module 10 includes hardware components such as processor and network interface card to perform these tasks. However, the BMC module 10 is not restricted to these hardware components.

As illustrated in FIG. 2A, the BMC module 10 includes base BMC 10B and BMC virtualization layer 10A. In the present embodiment, the base BMC 10B handles requests to and responses from the physical computer devices 130A˜130C. Ordinarily, if all three physical computer devices 130A˜130C are active and connected to the first management device 110, the base BMC 10B would traditionally (as an example) require three separate network interface cards (NIC) to correspondingly connect with the three physical computer devices 130A˜130C. Therefore, in order to cut down on the amount of hardware of the base BMC 10B, the virtualization layer 10A is provided so that only a minimal amount of hardware would be required, wherein this minimal amount of hardware would share the load of the entire system. In other words, the hardware component in the base BMC 10B may be shared and/or allocated to different virtualization instances of the BMC. It should be noted that the BMC module 10 is not restricted to having NIC card(s) to connect to the three physical computer devices 130A˜130C. In other different embodiments, the BMC module 10 may utilize any other suitable physical interface, transmission protocol, and/or hardware to connect with the physical computer devices 130A˜130C.

In the present embodiment, the first management device 110 has a plurality of first virtual machines VBMC11˜VBMC13, wherein each of the first virtual machines VBMC11˜VBMC13 correspond to a different physical computer device. For instance, since physical computer devices 130A˜130C are connected to the first management device 110, virtual machine VBMC11 corresponds to physical computer device 130A, virtual machine VBMC12 corresponds to physical computer device 130B, and virtual machine VBMC13 corresponds to physical computer device 130C. In the present embodiment, the virtual machines VBMC11˜VBMC13 are emulations or virtual instances of the BMC module 10. In other words, the operation of the virtual machines VBMC11˜VBMC13 are based on the computer architecture and functions of the BMC module 10.

As illustrated in FIG. 2A, in the present embodiment, the first virtual machines VBMC11˜VBMC13 are connected to the base BMC 10B through the virtualization layer 10A. Each of the first virtual machines VBMC11˜VBMC13 represent a virtual embodiment of the BMC system for one of the physical computer devices 130A˜130C. For example, when a physical computer device (ex. physical computer device 130A˜130C) is connected to the BMC module 10 of the first management device 110, the BMC module 10 will create a corresponding virtual machine (ex. virtual machine VBMC11˜VBMC13) and allocate hardware resources to it. For instance, the BMC module 10 may allocate processing power, memory storage, and/or access to communication modules.

In the present embodiment, the BMC module 10 manages the allocation of hardware resources to the first virtual machines VBMC11˜VBMC13 in order to maximize total efficiency of the hardware resources of the base BMC 10B. In this manner, by providing the virtualization layer 10A for the first virtual machines VBMC11˜VBMC13, the hardware resources of the base BMC 10B may be shared among many virtual machines VBMC11˜VBMC13. For instance, in the above example of using NIC cards, the total amount of NIC hardware required to be installed in the base BMC 10B may be decreased to just one, wherein the BMC module 10 could then efficiently and/or selectively allocate use of the NIC hardware to the virtual machines VBMC11˜VBMC13 (ie. the first virtual machines VBMC11˜VBMC13 would share the NIC hardware to communicate with their respective corresponding physical computer devices 130A˜130C).

As shown in FIG. 2A, once a virtual machine (ex. first virtual machines VBMC11˜VBMC13) has been created and allocated hardware resources by the BMC module 10, users or administrators at a frontend client or terminal device (terminal device 210A˜210C) may connect to the first virtual machines VBMC11˜VBMC13 through an interface 14 of the first management device 110 in order to monitor their respective corresponding physical computer devices 130A˜130C. As mentioned previously, the terminal device 210A˜210C may display monitoring status of the physical computer devices 130A˜130C through any user interface. For example, the user interface may be a Web User Interface or ipmitool. In the present example, an administrator in front of the terminal device 210A can remotely connect to the first management device 110 through a web browser running on the terminal device 210A. That is, the web browser on the terminal device 210A is connected to the first virtual machine VBMC11 through the interface 14. In other different embodiments, application software may be installed on the terminal device 210A˜210C to interface/interact with the first management device 110. It should be noted, that although the interface 14 of the first management device 110 in FIG. 2A has been drawn to be the interface between the terminal devices 210A˜210C for the first virtual machines VBMC11˜VBMC13, one skilled in the arts would easily recognize that separate interfaces 14 may be created between each virtual machine and their respective terminal devices.

Illustrated in FIGS. 2B˜2E are different embodiments of the virtualization of the base BMC 10B. Referring to FIGS. 2A and 2B, the physical computer devices 130A˜130C are connected to the first management device 110 through the IPMI 1 (Intelligent Platform Management Interface), IPMI 2, and IPMI 3 of the base BMC 10B. The IPMI is part of the baseboard management controller system and acts as the interface of communication between the base BMC 10B and the physical computer devices 130A˜130C. As illustrated in FIG. 2B, the virtualization layer 10A of FIG. 2A may be implemented by having virtual workspaces VW1˜VW3 under the file system where instances of the virtual machines VBMC1˜VBMC3 can be created. The Administrator may then gain access to these virtual machines VBMC1˜VBMC3 upon connecting to the Operating System of the first management device 110 from the terminal device 210 since the Operating System has access to these virtual machines VBMC1˜VBMC3 through its root file system. However, in another embodiment as shown in FIG. 2C, the virtual machines VBMC1˜3 can also alternatively be instantiated in the root file system. The Administrator can then have access to these virtual machines VBMC1˜3 through the Operating System.

FIG. 2D illustrates an embodiment of the present invention that supports Hypervisor in order to allow different Operating Systems to be supported. As shown in FIG. 2D, the Administrator can access from the terminal device 210 using an Operating System OS1 to connect to the first management device 110. In the present embodiment, a hypervisor layer is implemented between the virtualization layer 10A and the terminal device 200. The hypervisor layer allows support of different operating systems to be operated to access the virtual machines VBMC2 or VBMC3. In this manner, operating systems specific to operation of a particular virtualized BMC system may be supported. However, it should be noted that a combination or hybrid of the virtualization methods illustrated in FIGS. 2B˜3D may be implemented within the same device. For Example, as shown in FIG. 2E, the virtual machines VBMC1 and VBMC2 corresponding to the physical computer devices 130A and 130B may be implemented with the virtualization method of FIG. 2B (or FIG. 2C), while the virtual machine VBMC3 corresponding to the physical computer device 130C may be implemented vias the virtualization method of FIG. 2D.

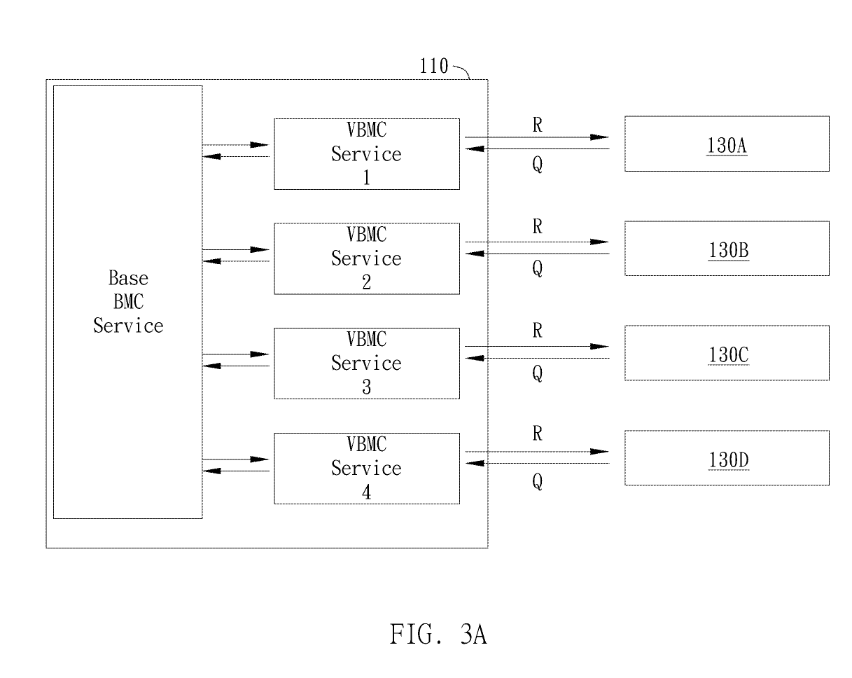

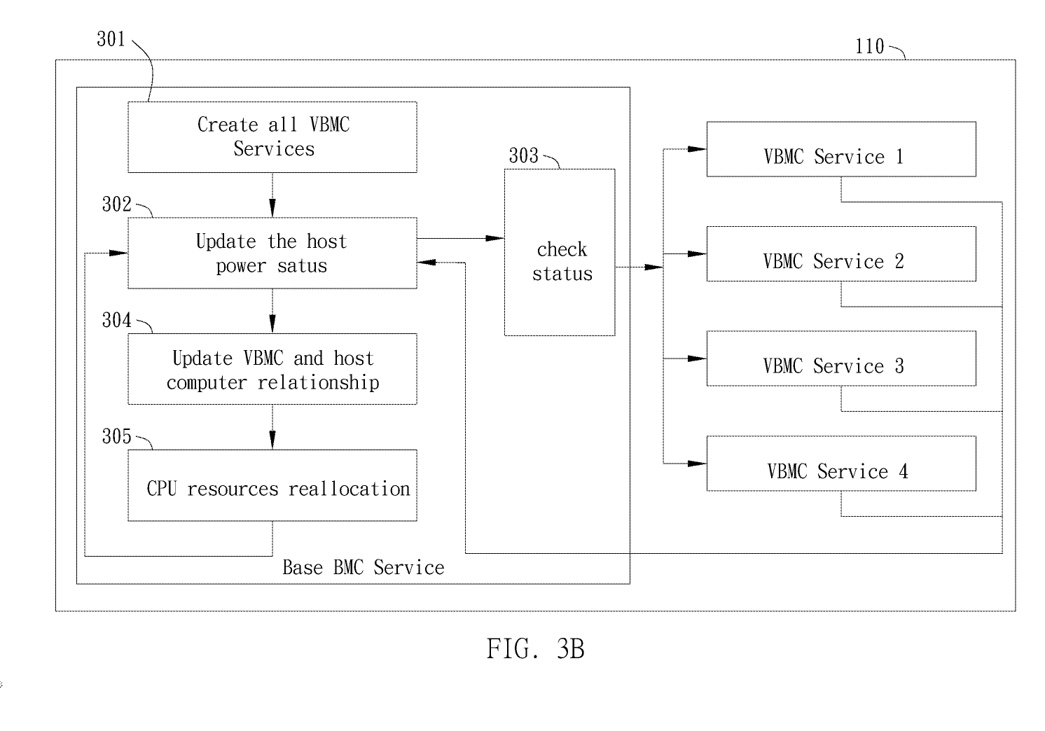

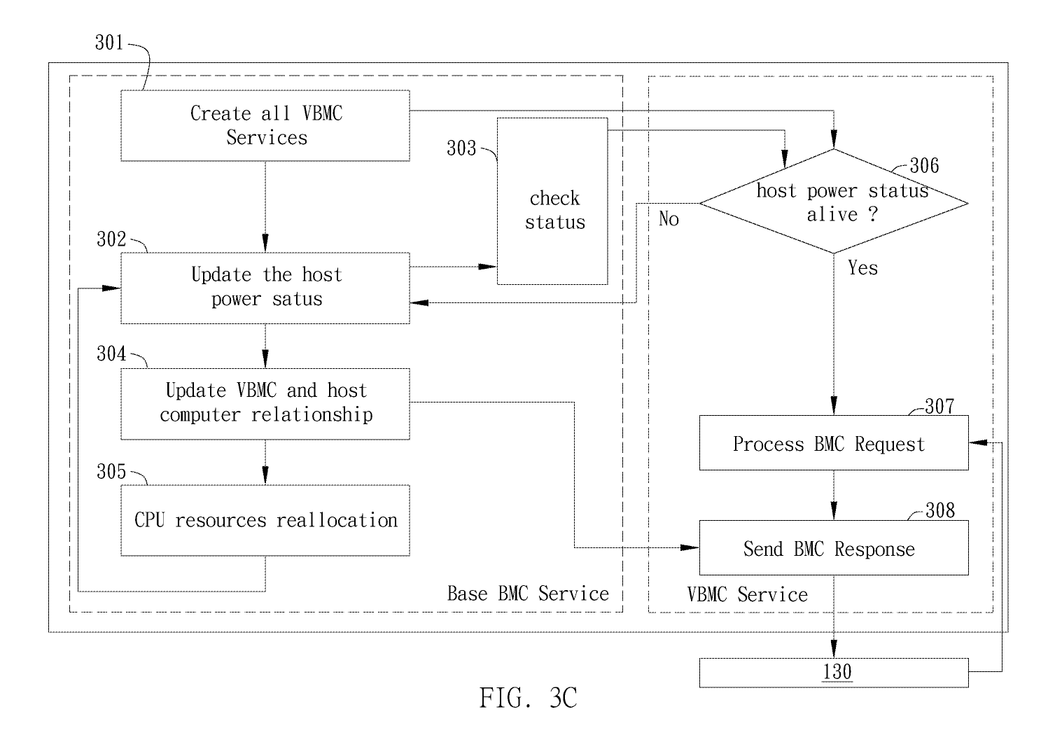

FIG. 3A illustrates an embodiment of the base BMC of a management device 110 (ex. first management device 110 or second management device 120) initializing VBMC services to correspond to each connected and active physical computer device (ex. physical computer devices 130A˜130D). In the present embodiment, VBMC services are created by the base BMC to manage and monitor the physical computer devices 130A˜130D.

Referring to FIGS. 3A and 3B, the base BMC will undertake steps 301˜305 to initiate monitoring of the physical computer devices 130A˜130D. In step 301, the base BMC will create VBMC services for each active and inactive physical computer device that is connected to the management device 110 (ex. first management device or second management device). For instance, in the present example shown in FIGS. 3A and 3B, when the physical computer devices 130A˜130D are connected to the management device 110, the base BMC will create VBMC services 1˜4 to respectively correspond to the physical computer devices 130A˜130D. After creating these VBMC services, step 302 of updating the host power status is performed. In the present step, when the VBMC services are first created and communicably connected to their respective physical computer devices, the VBMC services will return information about the physical computer devices to the base BMC. The base BMC then updates the power status of the physical computer devices according to the information returned by the VBMC services. For instance, all of the physical computer devices 130A˜130D may be connected to the management device 110, but one or more of the physical computer devices 130A˜130D may be active, while the rest are inactive. This information is updated in the management device 110 when the base BMC checks the statuses of the physical computer devices 130A˜130D through the VBMC services 1˜4.

In the present embodiment, the base BMC will periodically perform this status check (step 303) on the physical computer devices 130A˜130D in order to ensure that the physical computer devices 130A˜130D are running normally. The base BMC then performs step 304 of updating VBMC and host computer (physical computer device) relationship. In the present embodiment, after receiving information regarding the power statuses of the physical computer devices 130A˜130D from the VBMC services, the base BMC can determine whether the physical computer devices 130A˜130D are running optimally. For instance, if the physical computer device 130B is connected to the management device 110 but is non-active (power off), the base BMC would receive information from the VBMC service 2 that the power status of the physical computer device 130B is inactive/off or abnormal. The base BMC can then determine or conclude that the physical computer device 130B is in the process of being powered off or has been powered off. Accordingly, the base BMC can then update the VBMC and host computer relationship as “inactive”. Subsequently, in step 305, if one of the physical computer devices 130A˜130D was indeed inactive, the base BMC can reallocate the resources (such as CPU resources of the BMC system) dedicated to the virtual machine corresponding to the inactive physical computer device 130B to other active physical computer devices (ex. physical computer device 130A, 130C˜130D). In this manner, hardware resources of the BMC module 10 can be more efficiently shared among virtual machines with active physical computer devices.

FIG. 3C is another embodiment of FIG. 3B, wherein the flowchart of the base BMC and a single VBMC service is illustrated. Referring to FIGS. 3A—3C, when the base BMC first creates the VBMC service in step 301 and on subsequent status checks of step 303, the base BMC will ask the VBMC service to perform step 306 of confirming whether or not the power status of the corresponding physical computer device is alive. If the physical computer device responds with a BMC request Q, the VBMC service will receive the BMC request Q and process it in step 307, wherein the VBMC service will subsequently send a BMC response R in step 308 back to the physical computer device and client request. In this manner, the base BMC can periodically check on the physical computer device to see whether the physical computer device is active or not. If the physical computer device is inactive or in the process of powering off, the base BMC will update the virtual machine and physical computer device relationship in the management device 10, and accordingly reallocate the hardware resources of the base BMC that were dedicated to the virtual machine of the inactive physical computer device to the other virtual machines.

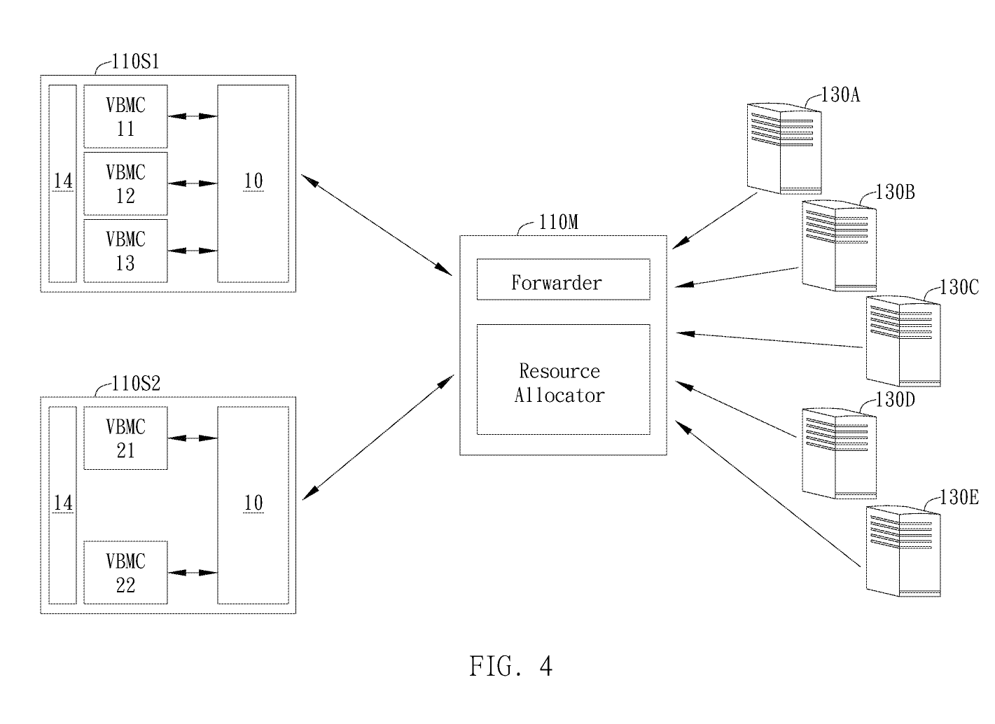

FIG. 4 illustrates another embodiment of the computer system 100 of FIG. 1. As shown in FIG. 4, the BMC system may be implemented in a master-slave hierarchal structure, wherein a master management device 110M may be used to connect with the physical computer devices 130A˜130E. In the present embodiment, at least one slave management device is connected to the master management device 110M. In the example of FIG. 4, the first management device 110S1 and second management device 110S2 respectively connect to the master management device 110M and act as the slave devices in a master-slave relationship.

As shown in FIG. 4, the master management device 110M has a forwarder module and a resource allocator module. In one embodiment, the master management device 110M includes embedded systems, server computers, desktop computers, or any other computer devices with a processor for data processing. In the present embodiment, the master management device 110M will forward communications between corresponding virtual machines (VBMC11˜13, VBMC21˜22) and physical computer devices (130A˜130E). In the instance where one of the physical computer devices 130A˜130E is powered off, inactive, and/or disconnected, the resource allocator module of the master management device 110M can reallocate processing power to handling communication between the other physical computer devices with their respective corresponding virtual machines.

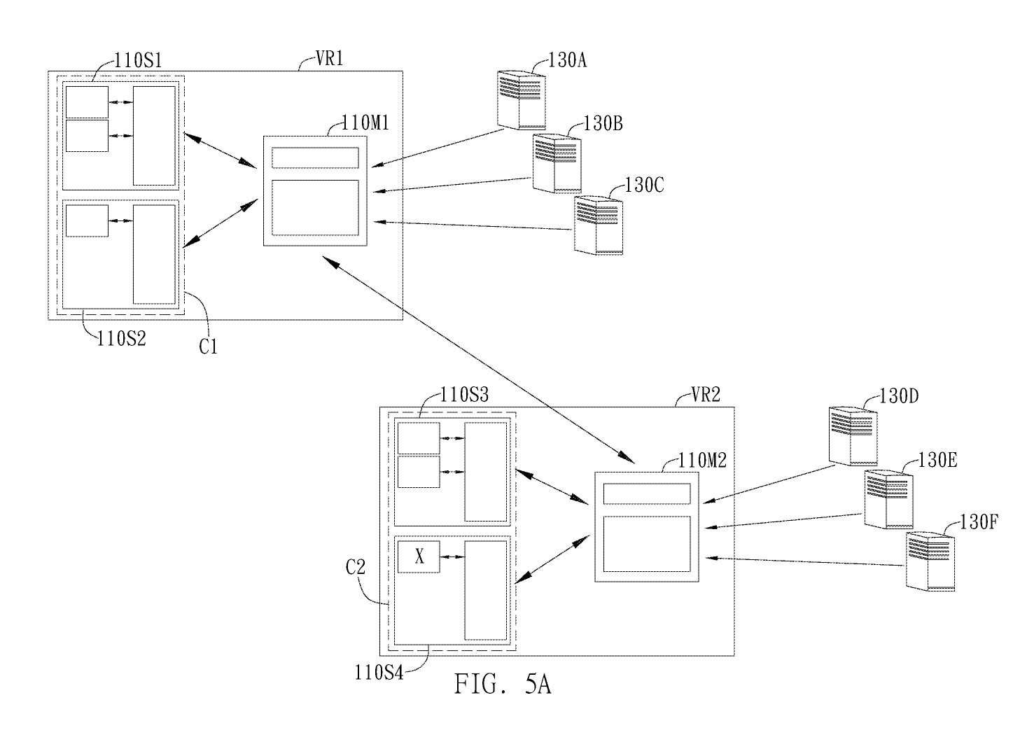

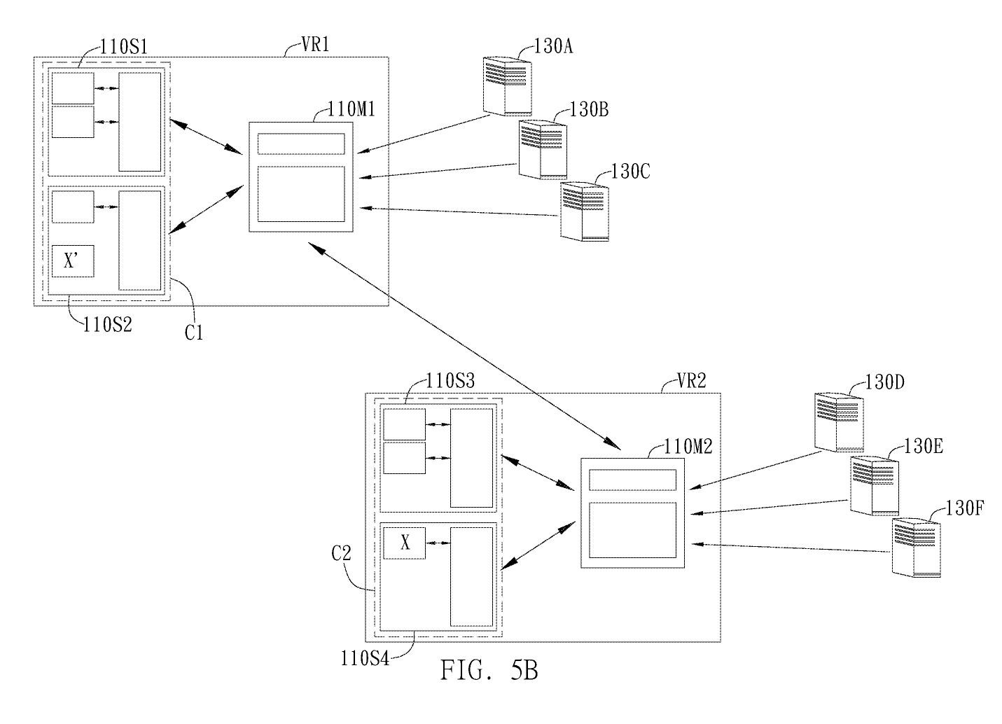

FIG. 5A is another embodiment of FIG. 4. As illustrated in FIG. 5A, at least two master management device 110M1 and 110M2 may be communicably connected with each other. In the present embodiment, region VR1 encompasses master management device 110M1 and its slave management devices 110S1 and 110S2, while region VR2 includes master management device 110M2 and its slave management devices 110S3 and 110S4. In one embodiment, since the master management device 110M1 and the master management device 110M2 are networked to each other, the master management device 110M1 and the master management device 110M2 can perform cross monitoring duties on each other. For instance, if one of the master management device 110M1 or 110M2 malfunctions or fails, when the other of the master management device 110M1 or 110M2 does not receive forward requests from the failed or malfunctioning master management device, the other of the master management device 110M1 or 110M2 would immediately know of the failure and can notify the Administrator and/or report the malfunctioning master management device. In this manner, a fail-safe mechanism is introduced between the two regions VR1 and VR2 so that any failures can be timely reported to the Administrator to prevent further damage or costs from occurring. In this manner, a failsafe mechanism is built into the system to automatically handle any failures occurring to any one of management devices in the system. In addition, in other different embodiments, master management devices are not restricted to only connecting to one other master management devices. In other words, each master management device may network with a plurality of other master management devices. In this manner, the entire system can be dynamically scaled up or scaled down according system requirements.

In addition, as illustrated in FIG. 5A, slave management devices may be deactivated to conserve power if the BMC system determines that the loading balance may be sufficiently handled by the other slave management devices. For instance, referring to the cluster C2 of the slave management devices 110S3 and 110S4, the master management device 110M2 of the region VR2 may determine that the load on slave management device 110S4 is too small to keep slave management device 110S4 running. In this instance, the master management device 110M2 can communicate with other master management devices in other regions (such as master management device 110M1 of region VR1) to see if they are able to accommodate processes running on the slave management device 110S4. Once the master management device 110M1 checks its slave management devices 110S1 and 110S2 of the cluster C1 and confirms to the master management device 110M2 that it would be possible to accommodate the processes that are running on the slave management device 110S4, the master management device 110M2 will initiate a migration process with the master management device 110M1 in order to migrate the virtual machine running on slave management device 110S4 to the cluster C1.

For instance, if the master management device 110M2 sees that the slave management device 110S4 is dedicating its resources to run only one virtual machine X (as shown in FIG. 5A corresponding to the physical computer device 130F), the master management device 110M2 can initiate a migration process of the virtual machine X to the master management device 110M1. In the present embodiment, as illustrated in FIG. 5B, after the master management device 110M1 has confirmed to the master management device 110M2 that it can accommodate handling the physical computer device 130F corresponding to the virtual machine X, the master management device 110M1 will instruct the slave management device 110S2 of cluster C1 to create a virtual machine X′. The master management device 110M2 will then migrate the virtual machine X of slave management device 110S4 to the newly created virtual machine X′ of slave management device 110S4 through the master management device 110M1. Thereafter, the master management device 110M1 will allocate processing resources to the virtual machine X′. The master management device 110M2 will then deallocate processing resources to the old virtual machine X and then delete the old virtual machine X. In the present embodiment, communication between the physical computer device 130F and the virtual machine X′ can be forwarded by the master management devices 110M2 and 110M1. In this manner, the entire system can dynamically determine the most efficient way to allocate resources to virtual machines or cluster of virtual machines. In other words, depending on the load balancing on the slave management devices, the master management devices 110M1 and 110M2 can jointly decide how to more efficiently utilize the slave management devices. As well, in the current structure, any number of new slave management devices, master management devices, and/or physical computer devices may be added to or subtracted from the system. That is, the present invention also provides benefits of improved flexibility in scalability of the BMC system.

Although the embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A computer system for baseboard management controller resource management, the computer system comprising:
a plurality of physical computer devices;
a first management device coupled to at least a portion of the plurality of physical computer devices, the first management device having a plurality of first virtual machines respectively corresponding to different physical computer devices of the portion of the plurality of physical computer devices;
a second management device coupled to the first management device, the second management device having a plurality of second virtual machines, each of the second virtual machines respectively corresponds to different physical computer devices of another portion of the plurality of physical computer devices;
wherein the first management device and second management device manage allocation of resources for the first virtual machines and second virtual machines to manage the physical computer devices.

2. The computer system of claim 1, wherein the first virtual machines and second virtual machines are virtual baseboard management controllers for managing and monitoring physical computer devices.

3. The computer system of claim 1, wherein the first management device and second management device cross monitor each other.

4. The computer system of claim 1, further comprising a master management device coupled between the plurality of physical computer devices and the first management device and the second management device.

5. The computer system of claim 4, wherein the master management device comprises a forwarder module and a resource allocator module, the forwarder module forwards communication between corresponding first management device and physical computer devices and between corresponding second management device and physical computer devices, the resource allocator module manages allocation of resources for managing the physical computer devices.

6. The computer system of claim 5, wherein the master management device comprises server computer, desktop computer, or data processing computer.

7. The computer system of claim 4, further comprising:
a second master management device coupled to the master management device, the second management device coupled to the second master management device, and the second master management device is coupled between the another portion of the plurality of physical computer devices and the second management device.

8. The computer system of claim 7, wherein the master management device and the first management device are networked in a master-slave structure, and the second master management device and the second management device are networked in a master-slave structure.

9. The computer system of claim 7, wherein the master management device and the second master management device cross-monitor each other.

10. The computer system of claim 7, wherein the master management device and the first management device are grouped in a first region, and the second master management device and the second management device are grouped in a second region.

11. The computer system of claim 10, wherein the master management device allocates resources to the second region, or the second master management device allocates resources to the first region.

12. The computer system of claim 1, wherein the virtual machines are instantiated in a virtual workspace in a filesystem.

13. The computer system of claim 1, wherein the virtual machines are instantiated in a root filesystem.

14. The computer system of claim 1, wherein the baseboard management controller manages temperature, humidity, power-supply voltage, fan speeds, communications parameters and operating system functions of the physical computer devices.
